(19) United States
(12) Patent Application Publication
(10) Pub. No.: US 2026/0048611 A1
(43) Pub. Date: Feb. 19, 2026

(54) Wet-Storage Brush Tray System and Related Methods

(71) Applicant: Robin Cole Andronaco, Arvada, CO (US)

(72) Inventor: Robin Cole Andronaco, Arvada, CO (US)

(21) Appl. No.: 18/445,674

(22) Filed: Aug. 15, 2024

(51) Int. Cl. B44D 3/12

(52) U.S. Cl. CPC B44D 3/125

(57) ABSTRACT

A wet-storage brush tray system designed to preserve the condition of paintbrushes used in fine art oil painting while eliminating physical problems and inconveniences common to historical solutions. The wet-storage brush tray system of the present invention includes a wet-storage brush tray and a non-slip mat. The tray features a front wall, two side walls, a shallow reservoir, and an inclined ramp with a non-slip mat, with the ramp and mat combination designed to prevent oil from reaching the brush handles, while also keeping the brushes stationary and preventing damage to the bristles. When used as a system with user-provided oil, the wet-storage tray prevents paint from oxidizing in the bristles between painting sessions while simultaneously cleaning and conditioning the brushes.

### FIELD

The present invention relates generally to the field of art supplies for the studio practice of fine artists working with oil paint and, more particularly, to a wet-storage brush tray system designed to preserve the condition of paintbrushes between painting sessions.

### BACKGROUND

Fine art oil painting, loosely defined as a medium consisting of colored pigments suspended in a drying oil (traditionally, linseed oil), has been part of human history for centuries. While it may have begun as early as the 7^{th} century, it did not become a widely used medium until the 15^{th} century when it was popularized in Europe by Jan van Eyck. Throughout the many years of oil painting's history, artists have continually dealt with brush cleaning and preservation as a part of their craft. There are many approaches to this problematic chore, but they all have the following goal in common: the pigment and drying oil (traditionally linseed oil, but modern paints often include walnut oil, high linolenic artist-grade safflower oil, poppyseed oil, and others) that together make up “oil paint” must not be allowed to dry/oxidize in the bristles of the brush, as this will render the brush stiff and useless. Brushes, particularly natural hair brushes, can be extremely expensive, making preserving their shape and extending their life span a high priority for painters.

Typically, the paint is removed from the brush with solvent, traditionally, turpentine, but today odorless mineral spirits or small number of alternative solvents are also available. The brushes are then cleaned with a detergent and/or soap and water and allowed to dry. To some extent, the paint can also be removed from the brush with oil in lieu of solvent prior to washing, and some artists with chemical sensitivities prefer this approach. While solvent/oil removal of the paint followed by washing does work well, the mechanical action of washing the brushes alters their shape over repeated washings, particularly for very small brushes. It is not possible to remove all the pigment without a great deal of movement (possibly not even then), and this has a tendency to splay and/or bend the bristles. It can drive small amounts of pigment deep into the base of the bristles near the ferrule, the metal part that attaches the bristles to the brush handle with glue and clamping. When this happens, the bristles will begin to splay. Over time, the brush loses its shape. Furthermore, careful hand-washing represents a very significant time investment for frequent painters.

Another, less commonly used alternative for preventing the paint from oxidizing in the brush is to keep the brush submerged in a liquid. Many liquids have been used for this: solvent (this can damage both the bristles and the glue inside the ferrule and shorten the life of the brush), water (not compatible with oil paint and can cause problems if it enters the paint in significant amounts), and oil (both drying oils like those that compose the paint, and non-drying oils, such as vegetable oil). There are also many solutions for keeping the brushes in a liquid, ranging from dipping them and laying them on a horizontal surface such as a piece of cardboard (messy and imprecise in terms of liquid coverage), setting the brushes bristle-down in a cup (which can damage the tips and accommodates only a small number of brushes), or laying them in a tray. This latter approach was Rembrandt's preferred technique in the 17^{th} century, and there are records of him using a wood tray of his own design, though it was a simple design that resulted in oily handles (due to capillary effect) and dirty brushes, as well as the brushes sliding forward, which damages the tips of the bristles. The few items currently on the market that purport to be of use for this are small, cumbersome, and expose the tips of the bristles to bending and other damage. They are also made of plastic and other non-durable materials that may break down over time requiring replacement, and/or react with the solvents used in painting.

With the aforementioned challenges, time-intensive solutions, and lack of products that address the number, ideal positioning, and natural longevity of the expensive brushes used by oil painters, it's clear that there is a need for a simple, elegant, user-friendly, and long-lasting solution for brush care between painting sessions that protects the brushes from oxidation and bending/breakage, frees up valuable time for the user, and accommodates the volume of brushes used by both professionals and hobbyists.

The present disclosure is directed at addressing this unmet need and overcoming, or at least improving upon, the disadvantages of the prior art.

### SUMMARY

The present disclosure provides a wet-storage brush tray system designed to preserve the condition of paintbrushes used in fine art oil painting while eliminating physical problems and inconveniences common to historical solutions. The wet-storage brush tray system of the present invention includes a wet-storage brush tray and a non-slip mat. The tray features a front wall, two side walls, a shallow reservoir, and an inclined ramp with a non-slip mat, with the ramp and mat combination designed to prevent oil from reaching the brush handles, while also keeping the brushes stationary and preventing damage to the bristles. When used as a system with user-provided oil, the wet-storage tray prevents paint from oxidizing in the bristles between painting sessions while simultaneously cleaning and conditioning the brushes.

The wet-storage brush tray system of the present disclosure saves a great deal of time and effort at the end of each painting session by allowing the user to bypass washing the brushes with soap and water. It also prevents toxic pigments such as lead and cadmium from being introduced into the public water supply from the artist paint. Avoiding the mechanical action of washing the brushes helps extend their life and prevents pigment from being driven up into the ferrule where it can oxidize/dry and contribute to the splaying of the bristles.

### BRIEF DESCRIPTION OF THE DRAWINGS

Many advantages of the present disclosure will be apparent to those skilled in the art with a reading of this specification in conjunction with the attached drawings, wherein like reference numerals are applied to like elements and wherein:

FIG. 1 is a front perspective view of an example of a wet-storage brush tray system with non-slip mat and paint brushes, with the tray in use and the reservoir filled with oil and brushes resting on the ramp, according to some embodiments;

FIG. 2 is a front perspective view of the wet-storage brush tray system of FIG. 1, shown without paint brushes, according to some embodiments;

FIG. 3 is a front perspective view of the wet-storage brush tray system of FIG. 1, shown without the paint brushes and oil, according to some embodiments;

FIG. 4 is a rear perspective view of a brush tray forming part of the wet-storage brush tray system of FIG. 1, according to some embodiments;

FIGS. 5A-5D are top plan, side plan, cross-sectional, and bottom plan views, respectively, of the brush tray of FIG. 4, according to some embodiments;

FIG. 6 is another front perspective view of the wet-storage brush tray system of FIG. 1, with the non-slip mat and paint brushes shown in broken lines, according to some embodiments;

FIG. 7 is another front perspective view of a wet-storage brush tray system of FIG. 1, with the non-slip mat shown in broken lines; according to some embodiments;

FIG. 8 is another front perspective view of the brush tray of FIG. 4, according to some embodiments;

FIG. 9 is a bottom perspective view of the brush tray of FIG. 4, according to some embodiments;

FIGS. 10A-10B are a top plan and bottom plan views, respectively, of the brush tray of FIG. 8, according to some embodiments;

FIGS. 11A-11B are side plan views of the brush tray of FIG. 8, according to some embodiments;

FIGS. 12A-12B are front plan and rear plan views, respectively, of the brush tray of FIG. 8, according to some embodiments; and

FIG. 13 is a flowchart depicting a method of using the wet-storage brush tray system of FIG. 1, according to some embodiments.

### DETAILED DESCRIPTION OF A PREFERRED EMBODIMENT

Illustrative embodiments of the disclosure are described below. In the interest of clarity, not all features of an actual implementation are described in this specification. It will of course be appreciated that in the development of any such actual embodiment, numerous implementation-specific decisions must be made to achieve the developers'specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The wet-storage brush tray and related methods disclosed herein boasts a variety of inventive features and components that warrant patent protection, both individually and in combination.

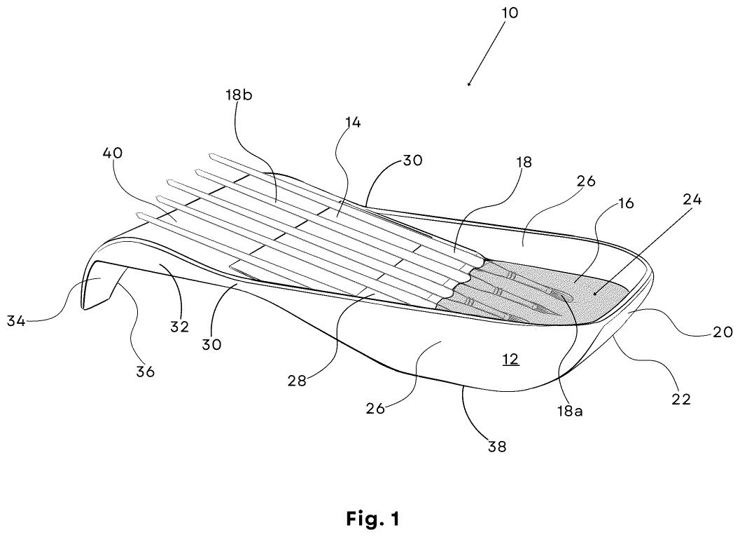

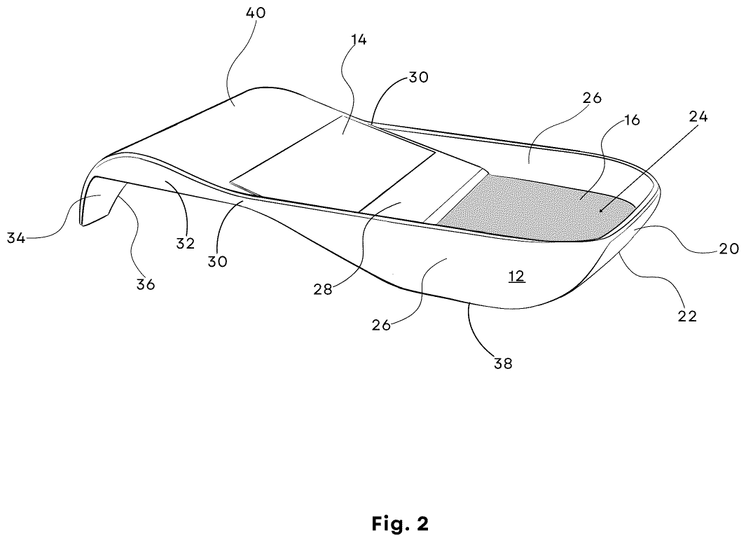

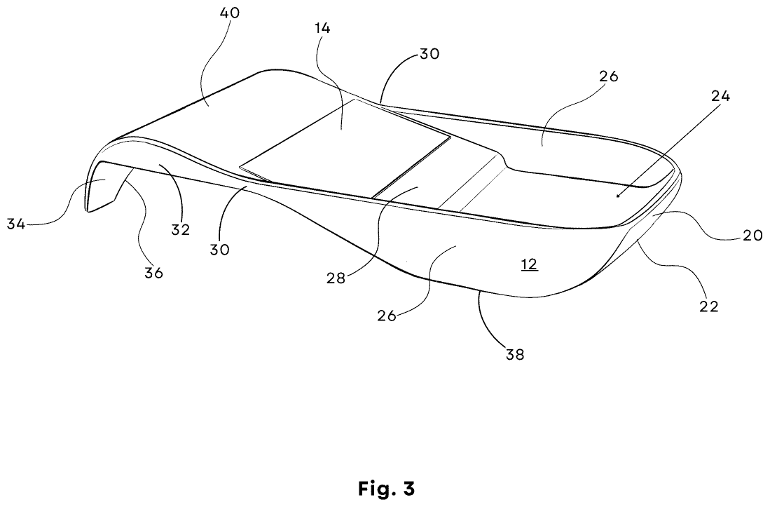

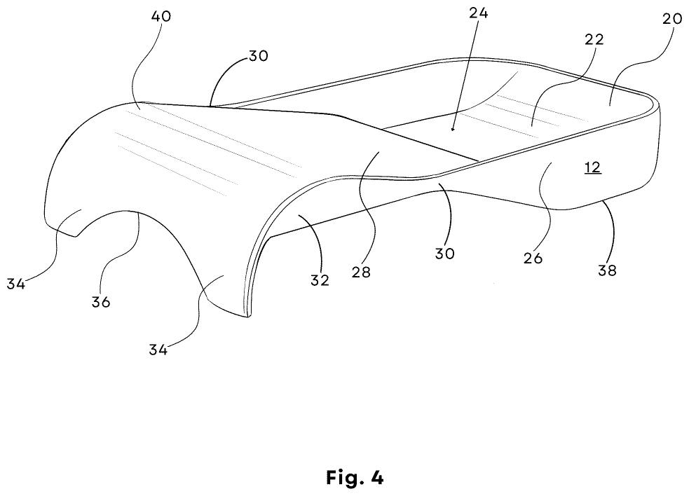

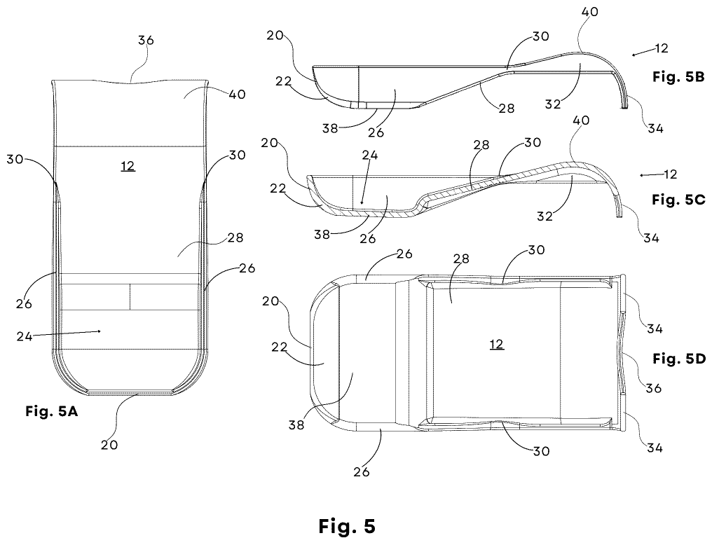

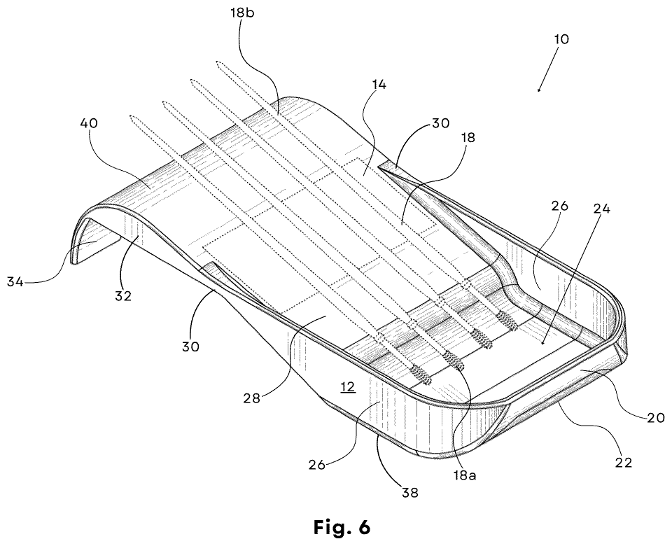

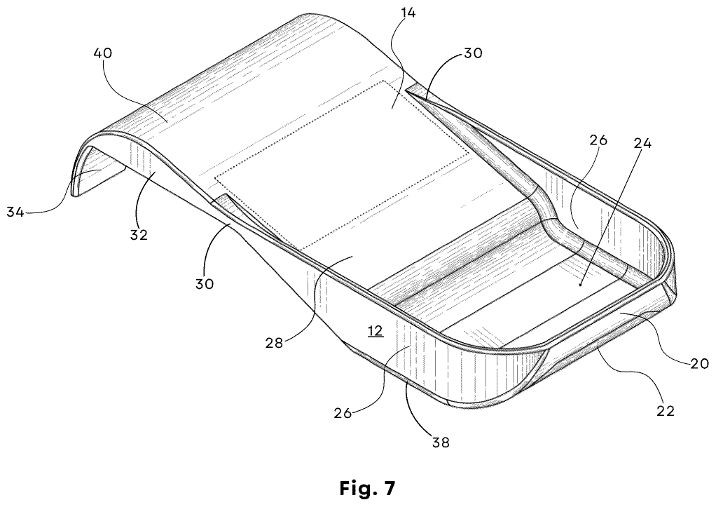

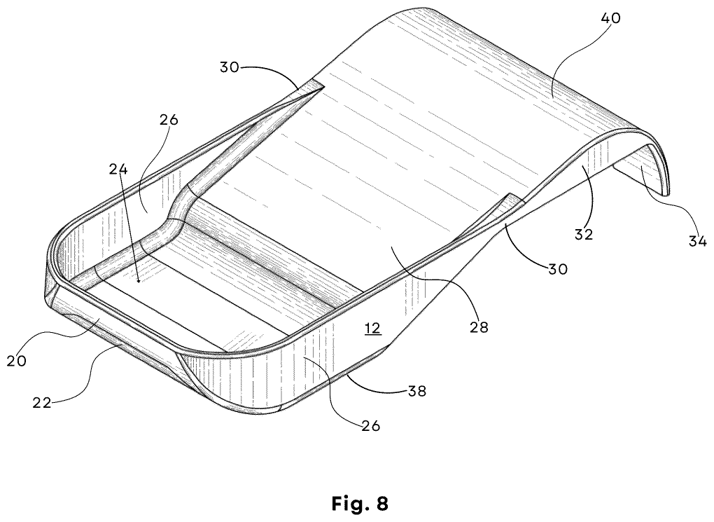

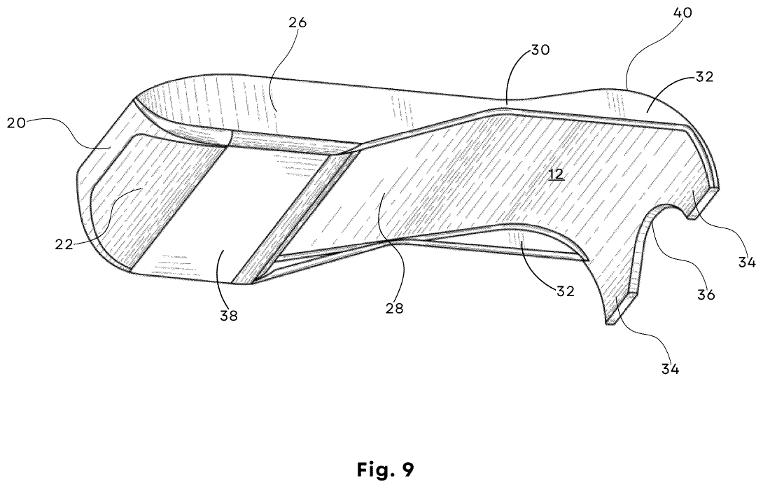

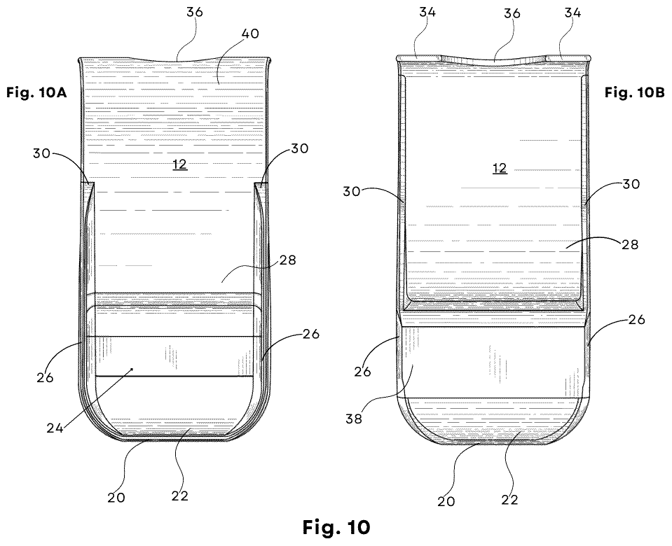

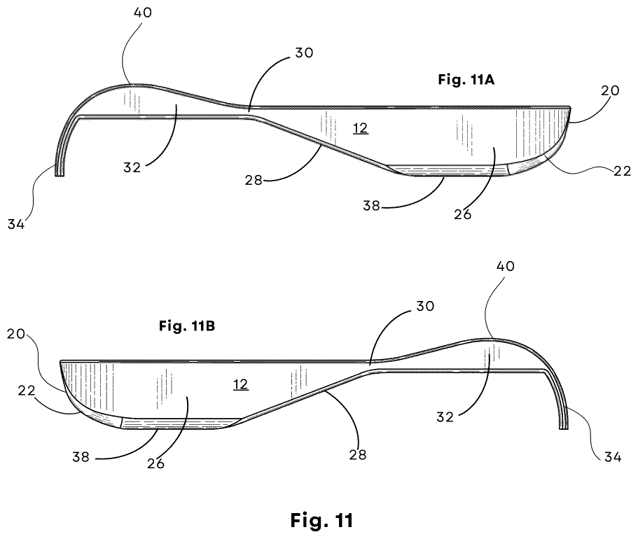

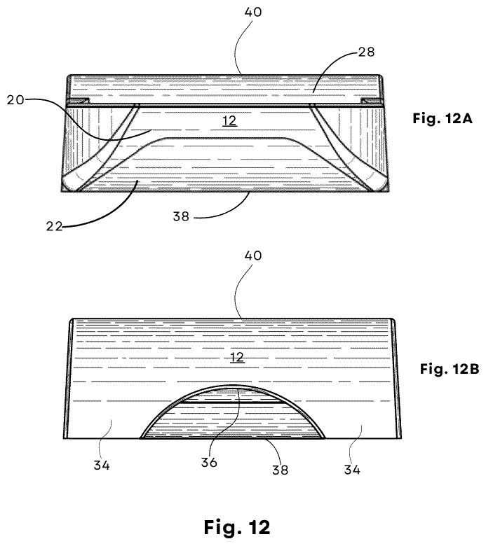

FIGS. 1-12 illustrate an example of a wet-storage brush tray system 10 including a wet-storage brush tray 12 and a removeable non-slip mat 14 according to some embodiments of the disclosure. By way of example, user-provided oil 16 and paintbrushes 18 may be used with the system 10. The wet-storage brush tray system 10 described herein is designed for use by fine art oil painters, and all references to brushes and paint in this document refer to tools specific to this discipline and familiar to one skilled in the art.

In some embodiments, the front end of the brush tray 12 comprises a shallow reservoir 24 having a curved front edge 22 and bounded by a front wall 20 disposed at the front end of the brush tray 12 and two side walls 26 extend longitudinally along the shallow reservoir 24. In some embodiments, the side walls 26 appear to diminish as the bottom of the reservoir rises to become an inclined ramp 28, eventually meeting the height of the walls 26 at a point of conjunction 30. By way of example, at this point of conjunction 30, the ramp 28 rises above the vertical side walls 26 so that the side walls 26 continue beneath the ramp 32, providing both visual elegance and strength and stability. In some embodiments, the ramp 26 then curves downward, bypassing the bottom edge of the side walls 26 and becoming two rear feet 34 divided by an arch 36 that echoes the overall curvilinear design.

By way of example, the shallow reservoir 24 at the front of the tray 12 is configured to hold user-provided oil 16 at a depth of approximately ½ inch to accommodate the bristle end 18a of most commonly used paintbrushes 18. Though full submersion of the tips/bristles 18a is ideal, in the case of extremely large brushes it is not necessary for the bristles 18a to be 100% submerged, as long as they are thoroughly coated with oil and partially submerged. The ideal 14-degree slant of the inclined ramp 28 is steep enough to prevent the oil 16 from creeping up the ramp 28 over days and months of use, but still shallow enough to prevent the brushes 18 from sliding forward to the end of the reservoir 24, where the bristles 18a might become bent or damaged. Extensive testing determined that 14 degrees is clearly ideal, though a variation of two degrees in either direction may also be within the realm of workability. By way of example, the non-slip mat 14 is configured to sit on the ramp 28 near the point of conjunction 30. In some embodiments, the exact placement of the non-slip mat 14 is determined by the user and may vary slightly according to the size and shape of the brushes 18 stored in the tray 12. By way of example, the non-slip mat 14 provides friction to aid the brush 18 in remaining stationary on the ramp 28 rather than sliding forward to the end of the reservoir 24. It also elevates the brush handles 18b very slightly off the ramp 28; this helps prevent the rise of oil 16 up the ramp 28 from the reservoir 24 along the handles 18b of the brushes 18 due to the capillary effect. By way of example, the capillary effect may be defined as the ability of a liquid to flow in narrow spaces without the assistance of external forces (and often in opposition to external forces like gravity). Without the mat 14 for example, the oil 16 could potentially flow slowly up the underside of the brush handles 18b from the point where the brush tip 18a is submerged. This effect would have made the handles of Rembrandt's brushes perpetually oily.

It is to be understood that the amount of oil 16 that may or may not end up on the handle of the brushes 18b is a direct result of the care with which the system 10 is used. For example, when brushes 18 with clean, dry handles 18b are placed gently on the ramp 28 with their tips 18a in the reservoir 24, and removed in the same way, the handles 18b will remain oil-free. If the brushes 18 are tossed haphazardly into the tray 12, as is often the case in casual daily use, the splashing and jostling may cause the handles 18b to become oily. If the user is employing a non-drying oil 16, as recommended, this is quickly remedied by wiping the handles 18b with a soft cloth. In addition, the non-slip mat 14 is configured for easy removal, which enables the mat 14 to be washed with soap and water, dried, and replaced once free of oil.

In some embodiments, the front end of the reservoir 24 exhibits a gentle curve 22 from the horizontal bottom plane 38 to the vertical front wall 20. By way of example, the curve 22 comprises a safety measure that ensures that, should the brushes 18 accidentally slide forward due to user error, the tips 18a will meet a gentle slope 22 rather than a perpendicular wall, thus limiting any bending (a concern with synthetic bristles) or breakage (a concern with natural bristles) or splaying (a concern with all types of bristles) of the bristles 18a.

In some embodiments, the high point 40 of the ramp 28 curves down to the back feet 34 of the tray 12 at (for example) a ten-inch distance from the ideal placement of the brush tips 18a in the middle of the reservoir 24. Because most brushes 18 have a standard handle 18b length of eleven inches, this leaves approximately one inch of the handle 18b extending into the air beyond the ramp 28, making the brush handle 18b easy to grasp and remove from the tray 12.

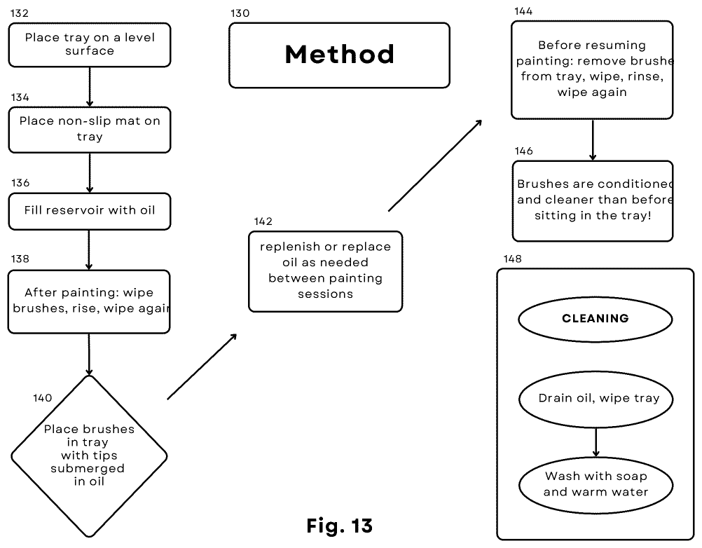

By way of example, FIG. 13 illustrates a method 130 of using the wet-storage brush tray system 10 described herein. In some embodiments, a first step 132 of the method 130 comprises placing the wet-storage brush tray 12 on a stable, level, horizontal surface.

In some embodiments, a next step 134 of the method 130 comprises placing the non-slip mat 14 near the point of conjunction 30 and ensuring that it rests flush against the ramp 28 and is centered between the left and right-side walls 26.

In some embodiments, a next step 136 of the method 130 comprises filling the reservoir 24 just below the height of the ramp 28 (approximately ½ inch) with non-drying oil 16, preferably food grade safflower oil.

In some embodiments, a next step 138 of the method 130 comprises wiping the excess paint from the brushes 18 at the end of a painting session, and may further comprise rinsing the brushes 18 clean of any additional paint in odorless mineral spirits (or other solvent of choice) to help keep the tray 12 and the oil 16 in the reservoir clean, though this rinsing is not strictly necessary-it simply helps the oil stay cleaner for a longer period. If the user desires to avoid solvents, the brushes 18 may be simply wiped.

In some embodiments, a next step 140 of the method 130 comprises placing the brushes in the tray 12 with the bristles 18a submerged in the oil 16 and the handles 18b resting on the ramp 28 atop the non-slip mat 14.

In some embodiments, a next step 142 of the method 130 comprises leaving the brushes 18 positioned with the bristles 18a in the oil for as long as the oil 16 remains fully fluid. This time period will vary according to season, temperature, humidity, airflow, and other factors, but it is generally a number of months if undisturbed. For example, if the brushes 18 are used multiple times per week or more, the oil 16 will need occasional replenishment when low and/or replacement when dirty, and this keeps it fluid indefinitely.

In some embodiments, a next step 144 of the method 130 comprises When ready to begin a new painting session, the user gently removing the brushes 18 from the oil 16 and thoroughly wiping any excess oil out of the bristles 18a with a paper towel or rag, for example at the start of a new painting session. In some embodiments, the user may choose to additionally rinse the brush 18 in odorless mineral spirits to ensure none of the non-drying oil 16 enters the paints, then wipe it again with a paper towel or rag before proceeding to the day's painting work.

By way of example, the user will find that brushes 18 that sit for several hours in the oil 16 are cleaner than when the user placed them in the tray 12. This is because the oil 16 facilitates the release and drawing out of the remaining pigment that is deep between the bristles 18a (the pigment that would be driven into the ferrule and contribute to splaying if they were manually washed with soap and water). This is a great added benefit. The user is now ready to begin painting with fresh, supple brushes 18 that have been conditioned and further cleansed by the oil 16, then cleaned of excess oil 16 by the user. Notably, this process can be repeated indefinitely.

In some embodiments, another step 148 of the method 130 comprises cleaning the wet-storage brush tray system 10. For example, when the oil 16, tray 12, and mat 14 become dirty with pigment, the wet-storage brush tray system 10 can be easily cleaned with soap and water. While the rate of pigment buildup will vary greatly according to the painting style and level of care the user exhibits, it is recommended that such cleaning take place at least once every 6-12 months. By way of example, the system 10 may be cleaned by removing the brushes 18, disposing of excess dirty oil 16, washing the tray 12 and mat 14 with soap and water, and allowing the components to dry before replacing the mat 14 on the tray 12 and filling the reservoir 24 with new oil 16.

The wet-storage brush tray system 10 saves a great deal of time and effort at the end of each painting session by allowing the user to bypass washing the brushes 18 with soap and water. It also prevents toxic pigments such as lead and cadmium from being introduced into the public water supply from the artist paint. Avoiding the mechanical action of washing the brushes 18 helps extend their life and prevents pigment from being driven up into the ferrule where it can oxidize/dry and contribute to the splaying of the bristles 18a.

In some embodiments, tray 12 may be made from a glazed, slip-cast ceramic material, though future iterations may include ram-cast ceramic or resin. This manufacturing process allows the precision of CAD modeling for consistent planes and angles. By way of example, ceramic has an advantage over plastics and polymers in that, in the context of the present disclosure, it is chemically inert and will not react with oil nor with any trace amounts of odorless mineral spirits or other cleaning solvents that might become mixed with the oil 16 during the process of cleaning and replacing the brushes 18. Ceramic is stable across temperatures and environments and will not crack (as would be likely with wood and other natural materials) with changes in heat or humidity. It is also heavy enough to keep the tray 12 extremely stable, aesthetically pleasing (as is typically important to the fine artist user), and it will last for years. There is no date of expiration or obsolescence. The wet-storage brush tray 12 may be passed down to future generations of users. When needed, overall cleaning of the wet-storage tray 12 can be easily accomplished with soap and water in the same way one would wash a dish.

In some embodiments, the non-slip mat 14 is composed of medium-stick PU gel, which is tacky enough to keep the lightweight brushes 18 in place with friction, but not so tacky that the handles 18a adhere and become difficult to remove. If needed, the mat 14 may be replaced separately and inexpensively.

By way of example, the 6.5-inch width of the ramp 28 can comfortably accommodate 8-24 brushes 18 (depending on the size of the brush and its handle) in a single layer. This is a sufficient number of brushes 18 for most users, whether hobbyist or professional, but if more are needed, multiple wet-storage tray systems 14 may be easily employed side by side. Alternatively, brushes 18 may be stacked in multiple layers (and this often happens in casual daily use), but they do not benefit from the non-slip mat and may slide forward. Employing multiple trays is the best solution for a large number of brushes.

Any of the features or attributes of the above-described embodiments and variations can be used in combination with any of the other features and attributes of the above-described embodiments and variations as desired.

From the foregoing disclosure and detailed description of certain preferred embodiments, it is also apparent that various modifications, additions and other alternative embodiments are possible without departing from the true scope and spirit. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A wet storage brush tray system, comprising:
a storage tray having a front portion including a reservoir configured to hold a volume of a liquid storage medium, a rear portion including a rear support element, and an inclined ramp surface extending between the reservoir and the rear support element, the storage tray further comprising a front wall positioned at a front end and a pair of side walls extending between the front end and the rear support element; and
a removable anti-migration feature configured for placement on the inclined ramp surface and having a brush engagement surface.

2. The wet storage brush tray system of claim 1, wherein the side walls at the front portion of the storage tray have a top rim and the side walls at the rear portion of the storage tray have a bottom rim.

3. The wet storage brush tray system of claim 2, wherein the top rim of the side walls intersect the inclined ramp surface at a point of conjunction.

4. The wet storage brush tray system of claim 3, wherein the inclined ramp surface comprises a front ramp portion extending toward the front portion of the storage tray from the point of conjunction and a rear ramp portion extending toward the rear portion of the storage tray from the point of conjunction.

5. The wet storage brush tray system of claim 4, wherein the front ramp portion extends vertically below the top rim of the side walls and the rear ramp portion extends vertically above the bottom rim of the side walls.

6. The wet storage brush tray system of claim 3, wherein the removable anti-migration feature is placed on the inclined ramp surface at the point of conjunction.

7. The wet storage brush tray system of claim 1, wherein the removable anti-migration feature comprises a mat having a length dimension, a width dimension, and a thickness dimension.

8. The wet storage brush tray system of claim 7, wherein the thickness dimension of the anti-migration feature elevates handles of associated paint brushes with respect to the inclined ramp surface.

9. The wet storage brush tray system of claim 7, wherein the mat is rectangular in shape.

10. The wet storage brush tray system of claim 1, wherein the inclined ramp surface curves downward at the rear portion of the storage tray to continuously form the rear support element.

11. The wet storage brush tray system of claim 1, wherein the rear support element includes a bottom edge configured to engage a resting surface.

12. The wet storage brush tray system of claim 11, wherein the bottom edge includes a concave portion.

13. The wet storage brush tray system of claim 12, wherein the concave portion divides the rear support element into a pair of support feet.

14. The wet storage brush tray system of claim 1, wherein the inclined ramp surface is inclined at an angle with a range of 12°and 16°.

15. The wet storage brush tray system of claim 14, wherein the inclined ramp surface is inclined at an angle of 14°.

16. The wet storage brush tray system of claim 1, wherein the reservoir has a planar bottom surface.

17. The wet storage brush tray system of claim 16, wherein the reservoir has a curved front edge extending between the planar bottom surface and the front wall.

18. A storage tray for wet storage of paint brushes, comprising:
a front portion including a reservoir configured to hold a volume of a liquid storage medium, a rear portion including a rear support element, and an inclined ramp surface extending between the reservoir and the rear support element;
a front wall positioned at a front end;
a pair of side walls extending between the front end and the rear support element, the side walls at the front portion of the storage tray having a top rim and the side walls at the rear portion of the storage tray having a bottom rim;
wherein:
the top rim of the side walls intersect the inclined ramp surface at a point of conjunction,
the inclined ramp surface comprises a front ramp portion extending toward the front portion of the storage tray from the point of conjunction and a rear ramp portion extending toward the rear portion of the storage tray from the point of conjunction, and
the front ramp portion extends vertically below the top rim of the side walls and the rear ramp portion extends vertically above the bottom rim of the side walls.

19. The storage tray of claim 18, wherein the inclined ramp surface curves downward at the rear portion of the storage tray to continuously form the rear support element.

20. The storage tray wherein the reservoir has a planar bottom surface and a curved front edge extending between the planar bottom surface and the front wall.
